(19) United States
(12) Patent Application Publication
(10) Pub. No.: US 2005/0023810 A1
(43) Pub. Date: Feb. 3, 2005

(54) Occupant and child seat detection device

(76) Inventors: Otman Adam Basir, Waterloo (CA); Emil Breza, Beamsville (CA); Jean-Pierre Bhavnani, Waterdown (CA)

Correspondence Address: Carlson, Gaskey & Olds, P.C., Suite 350, 400 W. Maple Road, Birmingham, MI, 48009, US

(21) Appl. No.: 10/903,878

(22) Filed: Jul. 30, 2004

Related U.S. Application Data
(60) Provisional application No. 60/491,114, filed on Jul. 30, 2003.

(51) Int. Cl. B60R 21/00; B60R 21/32

(52) U.S. Cl. 280/735; 180/268

(57) ABSTRACT

An occupant presence and child seat detection system includes several sensors to assist a capacitance based occupant presence detection system in distinguishing an occupant from a child seat on a wet vehicle seat. In one configuration, capacitance on the seating surface and wetness of the seating surface are measured. The determination of the presence of an occupant is based upon the measured capacitance and the measured wetness.

This application claims priority to U.S. Provisional Application Ser. No. 60/491,114, filed Jul. 30, 2004.

### BACKGROUND OF THE INVENTION

This invention relates to an occupant presence detection and classification system.

One difficulty with modern day safety restraint systems is the possibility of injury to an infant seated in a child/booster seat due to airbag deployment. It is therefore desirable to have the ability to disable the airbag when a child/booster seat is present. To achieve this, a manual override switch may be used to deactivate the airbag; however such a system is reliant on the operator of the vehicle's memory to manually disable the airbag. The preferred solution is therefore a mechanism that can determine the presence of a child/booster seat and send a signal to the restraints control module (RCM) to disable the airbag automatically.

Another vehicle safety application that is relevant to this invention is “after crash notification.” When a crash takes place it is quite crucial that proper medical care is identified and transported to the location of the crash so that crash victims are provided with the required medical attention. In order for health authorities to provide such service they need to be immediately informed of the number and age-class of occupants involved in the crash. To achieve this goal a mechanism is needed to identify whether a seat is occupied or not, and to identify whether the occupant is a child in a child-seat/booster or an adult, if the seat is occupied.

Capacitance-based occupant presence detection systems can determine the presence of an occupant on a vehicle seat by measuring the capacitance (or permittivity) on the seating surface. A human will have a higher capacitance than an empty seat or a child seat. However, a wet seat with a child seat could produce a sufficiently high capacitance reading to indicate the presence of an occupant.

### SUMMARY OF THE INVENTION

An occupant presence and child seat detection system includes several sensors and configurations to assist a capacitance based occupant presence detection system in distinguishing an occupant from a child seat, in particular, a child seat on a wet vehicle seat. In some disclosed configurations, capacitance on the seating surface and wetness of the seating surface are measured. The determination of the presence of an occupant is based upon the measured capacitance and the measured wetness.

In one embodiment, if the wetness exceeds a threshold, then the system checks the tension measured by a seat belt tension sensor. If the seat belt tension is above a threshold, it is determined that a child seat is present. Otherwise, an occupant is present on the seat.

In another embodiment, the capacitance measurement is adjusted based upon a level of wetness measured on the seat. In that way, the capacitance that is due to the seat wetness can be ignored or subtracted out. Then, the system can evaluate the capacitance signal to distinguish between an occupant and a child seat. Other embodiments are disclosed as well.

### BRIEF DESCRIPTION OF THE DRAWINGS

Other advantages of the present invention can be understood by reference to the following detailed description when considered in connection with the accompanying drawings wherein:

FIG. 1 is a schematic illustration of the presence detection system in a vehicle.

FIG. 2 is a first flowchart of the system of FIG. 1.

FIG. 3 is an alternate flowchart of the system of FIG. 1 using the capacitance, seatbelt, and belt tension sensors.

FIG. 4 is a third flowchart of the system of FIG. 1, using capacitance, and belt tension sensors.

FIG. 5 is a fourth flowchart of the system of FIG. 1 using the capacitance and wetness sensors.

### DETAILED DESCRIPTION OF THE PREFERRED EMBODIMENTS

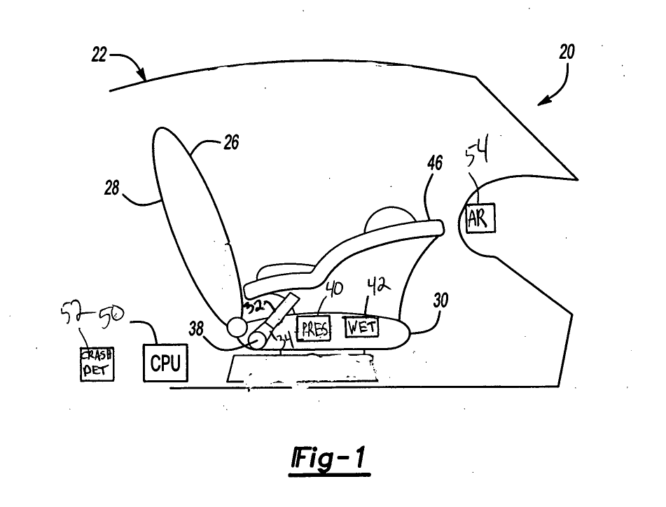

An occupant and child seat detection device 20 according to the present invention is shown in FIG. 1 installed in a vehicle 22 to detect the presence of an occupant in a vehicle seat 26. The seat includes a seat back 28 and a seat base 30. A seat belt 32 is attached to the seat 26 with a seat belt fastened sensor 34, which determines whether the seat belt 32 is fastened, and a seat belt tension sensor 38, which measures the tension in the seat belt 32.

Installed in the seat base 30 are a capacitive presence sensor 40 and a wetness sensor 42. The presence sensor 40 works generally by measuring the capacitance of an area on the seat base 30. The capacitance will be altered based upon the presence of a human occupant, because humans are mostly water. Based upon the capacitance measured on the seat base 30, the presence or absence of an occupant is determined. A suitable presence sensor 40 is disclosed in co-pending U.S. Ser. No. 10/319,431, filed Dec. 13, 2002 entitled, “Occupant Presence Detection Device,” which is hereby incorporated by reference in its entirety.

The wetness sensor 42 or moisture sensor may be a conductivity sensor measuring the conductivity of a portion of the seat base 30 to determine a level of wetness. The wetness measurement is combined with the capacitance measurement to construct a mapping for the various possible wetness-capacitance conditions that may occur in a seat under a range of seat wetness, occupants, and child seats. This mapping is used to detect occupants and, in addition, to sense if the seat 26 has become wet.

The presence sensor 40, wetness sensor 42, tension sensor 38 and fastened sensor 34 send their data to a CPU 50. The CPU 50, in the manner described below, uses the data from the sensors 40, 42 to determine whether an occupant is present on the seat 26 or whether there is a child seat 46 (occupied or not) on the seat 26. The system 20 further includes a crash detector 52, such as an accelerometer, and an active restraint 54, such as an airbag, associated with the seat 26. Based upon the determination by the CPU 50 whether there is an occupant in the seat 26, the CPU 50 determines whether to active the active restraint 54 in the event of a crash, as detected by the crash detector 52.

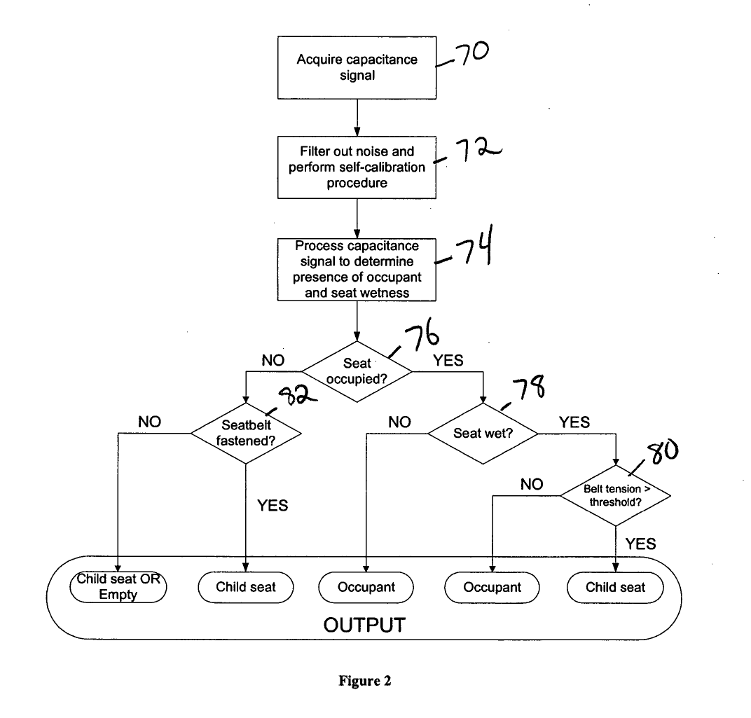

Referring to flowchart in FIG. 2 to describe the operation of the schematic of FIG. 1, in step 70, the presence sensor 40 acquires a capacitance signal that reflects a potential human presence. The capacitance signal is processed by a signal processing algorithm in step 72 to filter out noise and to calibrate the signal to achieve robust and stable measurement. In step 74, the CPU 50 processes the capacitance signal to determine a human presence that is at least the size of a 5th percentile female (103 lbs-113 lbs). Based upon the capacitance measured by the presence sensor 40, a preliminary determination of whether a person occupies the seat 26 is made in step 76.

If the seat is not wet, as determined by the wetness sensor 42 in step 78, then the seat 26 is determined to be occupied and the active restraint 54 is enabled. If the seat is wet, as determined by the wetness sensor 42 in step 78, then a determination of whether an occupant is present is made in step 80 based upon the tension measured in the seat belt 32 by the tension sensor 38. If the seat belt tension is over a threshold (ten pounds, for example), then the determination is made that there is a child seat 46 on the seat 26, because a human occupant would not tolerate belt tension over the selected threshold. If the seat belt tension is under the threshold, then the determination is made that there is an occupant on the seat 26 and the active restraint 54 is enabled.

If the presence sensor 40 determines that the seat 26 is not occupied in step 76, then in step 82, the fastened sensor 34 determines whether the seat belt 32 is fastened. If it is, then a child seat 46 is determined to be present. If it is not, then there is either an unbuckled child seat or the seat 26 is empty.

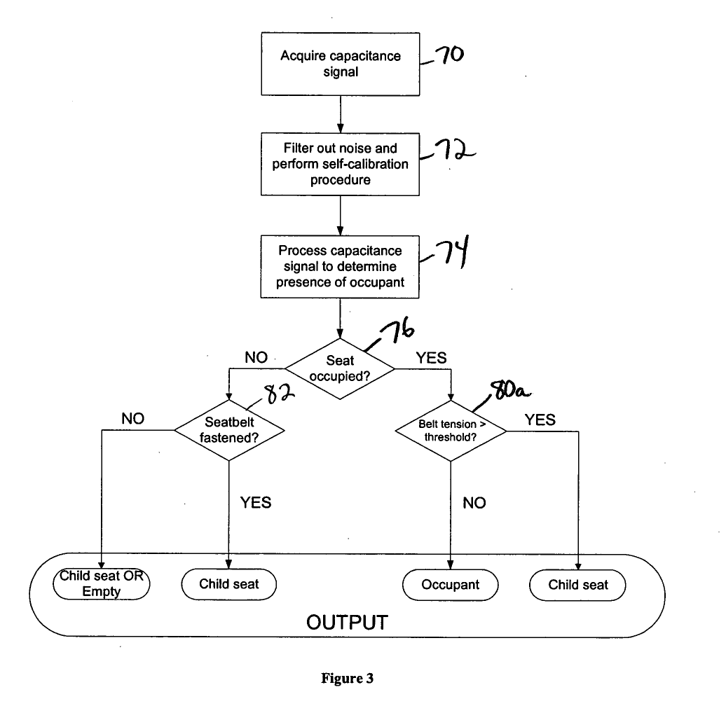

FIG. 3 illustrates the operation of an alternate embodiment, without the wetness sensor 42 of FIG. 1. In this case, it is determined that an occupant is present if the presence sensor 40 so indicates in step 76 as long as the belt tension is below the threshold, as determined in step 80a.

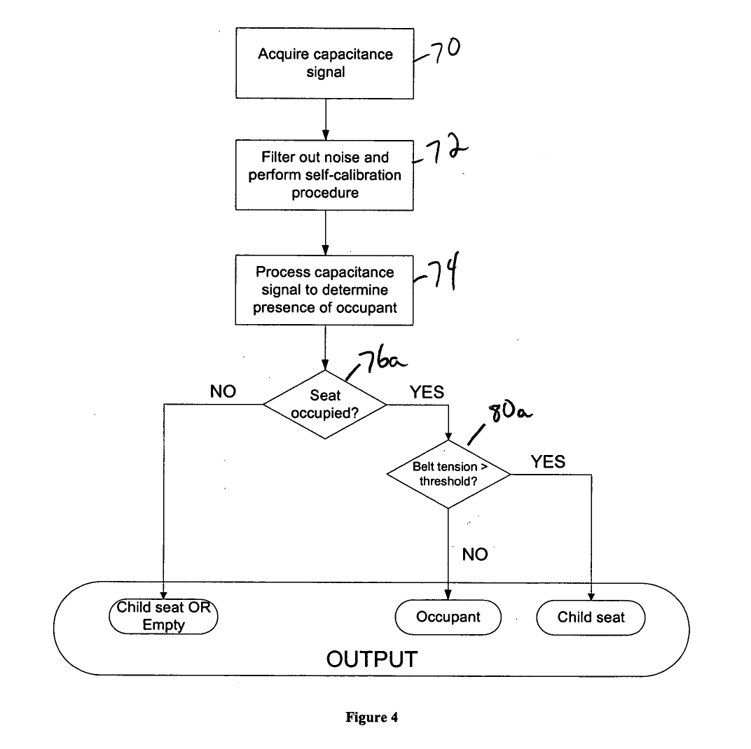

FIG. 4 illustrates the operation of another alternate embodiment, without the wetness sensor 42 and without the fastened sensor 34 of FIG. 1. In this embodiment, in step 76a it is determined that there is a child seat or an empty seat if the presence sensor 40 does not detect a sufficient capacitance on the seat base 30.

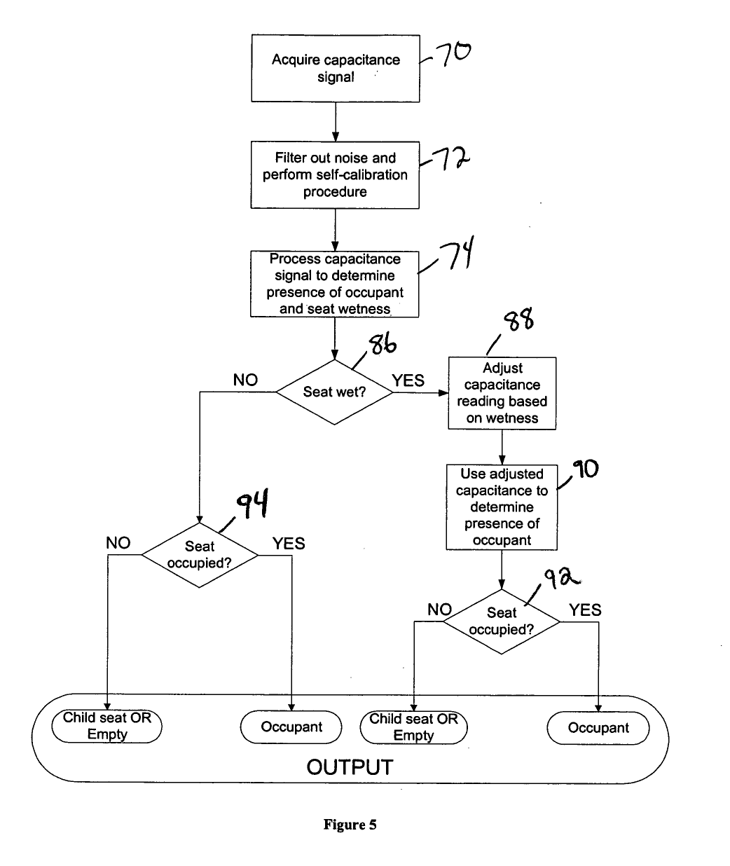

FIG. 5 illustrates an alternate operation of the embodiment shown in FIG. 1, without the fastened sensor 34. In this embodiment, it is first determined whether the seat base 30 is wet in step 86. If so, then the capacitance reading from the presence sensor 40 is adjusted in step 88 and analyzed (such as by comparison to a threshold) in step 90 to determine a presence of an occupant in step 92. If the seat 26 is determined not to be wet in step 86, then the original capacitance signal from the presence sensor 40 is analyzed in step 94 to determine the presence of an occupant versus an empty seat or a child seat.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. For example, several sensors have been described, each of which can be provided in several different forms that provide the same or similar function. Also, as explained above, different combinations of such sensors could be utilized within the scope of the present invention.

1. An occupant detection system comprising:
a presence sensor determining a presence of an occupant on a seating surface;
a wetness sensor determining a level of wetness near the seating surface; and
a processor for distinguishing the presence of an occupant and a child seat based upon signals from the presence sensor and the wetness sensor.

2. The system of claim 1 further including a tension sensor for measuring tension in a seat belt associated with the seating surface, the processor distinguishing based upon the tension measured by the tension sensor.

3. The system of claim 2 wherein, only if the seat is determined to be wet by the wetness sensor, the processor distinguishes based upon the tension measured by the tension sensor.

4. The system of claim 3 wherein the presence sensor is a capacitance-based sensor that measures capacitance on the seating surface.

5. The system of claim 4 wherein the presence sensor determines the presence of an occupant based upon the measured capacitance and based upon the level of wetness, as determined by the wetness sensor.

6. A method for determining a presence on a seat including the steps of:
measuring capacitance on a seating surface;
measuring wetness on the seating surface; and
determining a presence based upon the measured capacitance and the measured wetness.

7. The method of claim 6 further including the step of altering the measured capacitance based upon the measured wetness.

8. The method of claim 6 further including the step of measuring a tension in a seat belt associated with the seating surface, wherein the step of determining a presence is based upon the measured tension.

9. The method of claim 8 wherein the step of determining a presence includes the step of distinguishing between an occupant and a child seat.

10. The method of claim 9 wherein the step of distinguishing between the occupant and the child seat is based upon the measured tension only if the measured wetness exceeds a threshold.
